(19) United States
(12) Patent Application Publication
(10) Pub. No.: US 2020/0362973 A1
(43) Pub. Date: Nov. 19, 2020

(54) NON-STICKING ROTARY VALVE

(71) Applicant: TECAN TRADING AG, Maennedorf (CH)

(72) Inventors: Michael J. KENNEDY, Los Gatos, CA (US); Torleif Ove BJÖRNSON, Gilroy, CA (US); Beat BOLLI, Männedorf (CH)

(73) Assignee: TECAN TRADING AG, Maennedorf (CH)

(21) Appl. No.: 15/931,465

(22) Filed: May 13, 2020

Related U.S. Application Data
(63) Continuation-in-part of application No. 16/411,937, filed on May 14, 2019.

(51) Int. Cl. F16K 11/074; F16K 25/00; F16K 31/04

(52) U.S. Cl. CPC F16K 11/0743; F16K 31/047; F16K 25/005

(57) ABSTRACT

A rotary valve comprises a stator member with a planar stator face, the stator member having a plurality of stator channels for conducting a fluid and a rotor member with a planar rotor face facing and in contact with the stator face, the rotor member having at least one rotor channel. The rotor member is rotatable with respect to the stator member, such that in specific rotor positions, the rotor channel interconnects two of the stator channels, such that the stator channels are in fluid communication. One of the stator member and the rotor member is made of ceramics material, wherein the other one of the stator member and the rotor member is made of a polymer material. The ceramics material is coated with a diamond-like carbon (DLC).

### CROSS-REFERENCE TO RELATED APPLICATIONS

This application is a continuation-in-part of, and claims priority to, pending U.S. patent application Ser. No. 16/411,937, filed May 14, 2019, the disclosure of which is hereby incorporated herein by reference in its entirety.

### TECHNICAL FIELD

The invention relates to a rotary valve.

### BACKGROUND

Rotary valves may be used in laboratory automation systems for distributing liquids, such as reagents, dilutions, samples, etc. A rotary valve usually comprises a stator member with stator channels and a rotor member, which faces the stator and which comprises a rotor channel. Dependent on different rotary positions, the rotor channel interconnects different stator channels with each other. A pump may convey a liquid from a first container and/or channel into the rotary valve and the rotary valve may distribute the liquid into other containers and/or channels dependent on its rotor position.

Dependent on the materials used for the stator member and the rotor member, it may be that the stator member and the rotor member stick together, in particular, when specific liquids are present within the valve. Sticking may occur in the interface between the rotor member and stator member as reagents dry during times when the system is idle and the valve is not operating. In general, the exact mechanism is not fully understood. It may be a combination of a glue effect and of solids and/or salt crystals bridging pits in the mating rotor face and stator face, pinning the faces together to prevent rotation. Sticking of highly smooth and flat surfaces may also occur when wetted by certain reagents, which enhance contact and molecular attraction between the surfaces.

It also may be that grooves develop in the faces of the stator member and/or the rotor member. Grooving may be caused by solids present in the reagents, such as glass or magnetic beads, salt crystals from dried regents, etc . It is known that soft polymer materials may be prone to grooving in face-seal valve usage. It is also known that ceramics such as Al₂O₃ may be resistant to grooving, but subject to sticking in certain applications. The formation of grooves may limit the life time of the valve.

### SUMMARY

There may be a need for a rotary valve that is less susceptible to the above mentioned effects. There also may be a need for a rotary valve with a long life time and/or with a rotor member and a stator, which are less prone to sticking and/or groove forming.

These needs may be met by the subject-matter of the independent claims. Further exemplary embodiments are evident from the dependent claims and the following description.

The invention relates to a rotary valve comprising a stator member with a planar stator face, the stator member having a plurality of stator channels for conducting a fluid and a rotor member with a planar rotor face facing and in contact with the stator face, the rotor member having at least one rotor channel. The rotor member is rotatable with respect to the stator member, such that in specific rotor positions, the rotor channel interconnects two of the stator channels, such that the stator channels are in fluid communication.

The stator member and the rotor member may be accommodated in a housing of the rotary valve, wherein the stator member may be statically connected with the housing and the rotor member may be rotatably connected with the housing. The rotor member may be rotated by a step motor. A pump, such as an automatically actuated syringe may be connected to one of the stator channels.

The housing of the rotary valve furthermore may comprise means for pressing the rotor face against the stator face, such as a spring, and/or means for aligning the rotor face with the stator face, such as an elastomeric backing disk, which may be attached to a backside of the rotor member and/or may be located between the backside of the rotor member and a step motor coupler.

According to an embodiment of the invention, one of the stator member and the rotor member is made of ceramics material and the other one of the stator member and the rotor member is made of a polymer material, in particular a polymer material mixed with particles. In particular, the stator member may be made of ceramics material and the rotor member may be made of the polymer material or a polymer material mixed with particles.

Experiments have shown that using a polymer material, in particular a polymer material mixed with particles lowers the sticking of the members and the forming of grooves significantly. Thus, the rotary valve may be used with any type of liquids, which tend to form sticking substances, when drying. The rotary valve also may be used with liquids, which may contain particles, which may cause the forming of grooves.

Lowering the sticking may result in a low friction between the rotor member and the stator member during operation and after extended periods of rest. An expensive, complex and/or large sized drive mechanism may be avoided.

Furthermore, the rotary valve may be especially suited for being operated with low liquid pressures, such as pressures up to 10 bar. When low sticking materials are used, for such valves, the force and/or the spring member pressing the rotor member against the stator member may be chosen smaller and/or the drive mechanism may be designed smaller as compared to high pressure valves.

Additionally, with the chosen materials, the life time of the rotary valve may be significantly prolonged. In particular, a valve as described herein may perform millions of valve moves.

The polymer material may be or may comprise a fluorocarbon, such as ethylene tetrafluoroethylene (ETFE). The ceramics material may be or may comprise aluminum oxide (Al₂O₃). The sticking and forming of grooves was particularly low with these combinations of material.

According to an embodiment of the invention, the ceramics material is coated with diamond-like carbon (DLC). In particular, the ceramics material may be aluminum oxide (Al₂O₃) coated with diamond-like carbon. A coating with diamond-like carbon (DLC) may further reduce the forming of grooves. The coating with diamond-like carbon may be made with vapor deposition.

According to an embodiment of the invention, the particles may be and/or may comprise beads. Beads may be particles with substantially the same diameter in any direction. An average diameter of the particles may deviate from a specific diameter in a specific direction not more than by the factor of 2.

According to an embodiment of the invention, the particles may be and/or may comprise fibers. A fiber may have a diameter in one direction, which is at least 10 times higher than a minimal diameter.

According to an embodiment of the invention, the particles may be made of at least one of glass and/or carbon. In general, the particles may be made of a material, which is harder than the polymer material.

According to an embodiment of the invention, the polymer material is mixed with electrically conducting particles such that the other one of the stator member and the rotor member becomes electrically conducting. For example, the polymer material may be mixed with at least 20% carbon fibers to render the mixture of polymer material and carbon fibers electrically conducting.

It may be that a static charge builds up on the rotor member and the stator member, when they are rotated with respect to each other. A molecular scission process may create chelates of the material of the polymer material, such as ETFE, which may adhere to charged surfaces of the rotor member and the stator member. For example, the chelates may form a molecular bond to the surface of the ceramics material and may damage the polymer material against which they are moved during rotation of the rotor member and the stator member. Reducing the static charge may help that the chelates are washed away during valve operation Otherwise, the static charge may attract charged chelates that may adhere to rotor and stator surfaces. Removing the static charge may enable reagents without molecular charge (such as DI water) to wash away chelates (for example made of ETFE during valve operation. The static charge may be removed by making the member made of polymer material electrically conducting. The forming of chelates of polymer material may be reduced by coating the ceramics material with DLC.

According to an embodiment of the invention, the particles may have a diameter of less than 50 μm. It may be that an average diameter of beads is less than 50 μm and/or that a minimal diameter of fibers is less than 50 μm. The diameter may be between 10 μm and 50 μm, in particular between 15 μm and 45 μm. The diameter may be about 30 μm.

According to an embodiment of the invention, the particles may have a volume content between 10% and 30% with respect to the polymer material. For example, the rotor member and the stator member, respectively, may be made from 70% to 90% from the polymer material and from 10% to 30% from the particles. The volume content of the particles may be between 15% and 25%, for example about 20%.

As an example, the rotor member or the stator member may be machined or injection molded from an ETFE polymer formulation with 20% glass beads. This may provide high wear durability and sealing performance.

It may be that the face of the respective member made of the polymer material mixed with particles, i.e. the rotor face and/or the stator face is lapped, for example after machining or molding. It also may be that the rotor face and/or stator face is diamond-turned after machining or molding. In both cases, a flat and smooth surface may be generated.

According to an embodiment of the invention, the one of the stator member and the rotor member may be made one-piece from the ceramics material. Also, the other one of the stator member and the rotor member may be made one-piece of the polymer material mixed with the particles. Both or one of the two members may be made one-piece of the respective material. The term “one-piece” in this context may mean that the respective member is not put together from pieces that are glued or somehow attached together. The material of the respective member may be homogeneous.

According to an embodiment of the invention, the rotor channel may be a groove in the rotor face. The rotor face may be a substantially planar surface in which the rotor channel is provided. The rotor channel may be a longitudinal groove in this surface, which may extend in a direction orthogonal to an axis of rotation of the rotor member.

According to an embodiment of the invention, the stator channels are axially extending with respect to an axis of rotation of the rotor member. The stator face may be a substantially planar surface, in which the stator channels are provided. The stator channels may have openings in the stator face.

According to an embodiment of the invention, edges of a channel in one of the stator member and the rotor member may be rounded with a radius between 15 μm and 35 μm, such as about 25 μm. The radius may be a minimum radius of the edge. The edge may be at a transition between the stator face and a stator channel and/or between the rotor face and the rotor channel.

In particular, the edges in the member made of ceramics material, such as the stator member, may be rounded. For example, the face of the ceramics member may be finished with a lapping process to achieve a flat surface with soft edges at the interface to the member made of polymer material mixed with particles. This lapping process may create a uniformly smooth surface to enable effective and reliable valve sealing performance. For example, the lapping process may prevent sharp edges on a ceramics stator member from wearing or damaging a molded ETFE rotor member during valve operation.

According to an embodiment of the invention, the rotor member may be part of a rotor assembly, which comprises a coupling element connectable to an electrical motor. The rotor member, which may be made of the polymer material mixed with particles, may be attached to the coupling element, which may be attached to the electrical motor, such as a step motor. A flat on the motor driveshaft may be provided to index the rotor channel position to a plurality of channel positions in the stator. The coupling element may be made of different materials, such as metal or a hard polymer such as PEEK. The rotor assembly may be rotatably mounted to the housing of the rotary valve, for example via a bearing.

It may be that the rotor member is made of a polymer material, which is mixed with electrically conducting particles, such that the rotor member becomes electrically conducting. In this case, the rotor member may be grounded to the motor drive shaft. This may reduce a generation of static charge in the rotor member. Grounding of the rotor member may be done with a coupling element made of an electrically conducting material, such as a metal, for example stainless steel.

According to an embodiment of the invention, a balancing member may be arranged between the coupling element and the rotor member. The rotor member may not be directly attached to the coupling element, but a balancing member may be provided between, which is adapted to balance unevenness between the mating surfaces of the coupling element and the rotor member, thus ensuring uniform contact pressure. The balancing member may be a flat member and/or may be shaped like a disk. The balancing member may be attached to a backside of the rotor member, which is opposite to the rotor face.

According to an embodiment of the invention, the balancing member may be made of a material, such as a polymer material, having a higher elasticity than the polymer material of the stator member. In such a way, the balancing member may balance misalignments and unevenness and may press the rotor member against the stator member.

According to an embodiment of the invention, the balancing member may be made of an elastomer material, such as rubber or a steel spring. For example, the balancing member may be made of ethylene propylene diene methylene (EPDM). A balancing member in the form of an elastomer disk may ensure a complete contact between polymer face and ceramics face.

According to an embodiment of the invention, the rotary valve may further comprise a housing part, in which the rotor assembly is rotatably mounted, and a preload spring arranged in the housing part between the coupling element and a shoulder of the housing for pressing the rotor member against the stator member. The housing part may be a valve body, which comprises a cavity in which the rotor assembly is accommodated.

According to an embodiment of the invention, the housing part and/or valve body may have slots for attaching and/or replacing mounting screws on a fully assembled valve by means of a snap-fit connection.

The rotary valve furthermore may comprise a bearing element arranged between the spring and the coupling element.

The preload spring, which may be a steel spring, and the balancing member may be seen as a preload system of the rotary valve. The spring may provide a force required to seal the rotor member against the stator member.

A flexing of the rotor member may cause a leak in the rotary valve. The balancing member may compensate for this effect by preventing the rotor member from flexing under the force of the preload spring and/or may encourage the rotor member with its rotor face to fully and uniformly seat against the stator face.

The coupling element may comprise a recess, which may keep the balancing member centered on an axis of rotation. This may enable a proper alignment of the preload force of the spring on the rotor member.

These and other aspects of the invention will be apparent from and elucidated with reference to the embodiments described hereinafter.

### BRIEF DESCRIPTION OF THE DRAWINGS

The accompanying drawings, which are incorporated in, and constitute a part of this specification, illustrate implementations of the present teachings and, together with the description, serve to explain the principles of the disclosure. Below, embodiments of the present invention are described in more detail with reference to the attached drawings. In the figures:

FIG. 1 shows an exploded view of a rotary valve according to an embodiment of the invention.

FIG. 2 shows a perspective sectional view of the rotary valve of FIG. 1.

FIG. 3 schematically shows a stator face for a rotary valve according to an embodiment of the invention.

FIG. 4 schematically shows a rotor face for a rotary valve according to an embodiment of the invention.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary implementations of the present teachings, examples of which are illustrated in the accompanying drawings. Generally and/or where convenient, the same reference numbers will be used throughout the drawings to refer to the same or like parts.

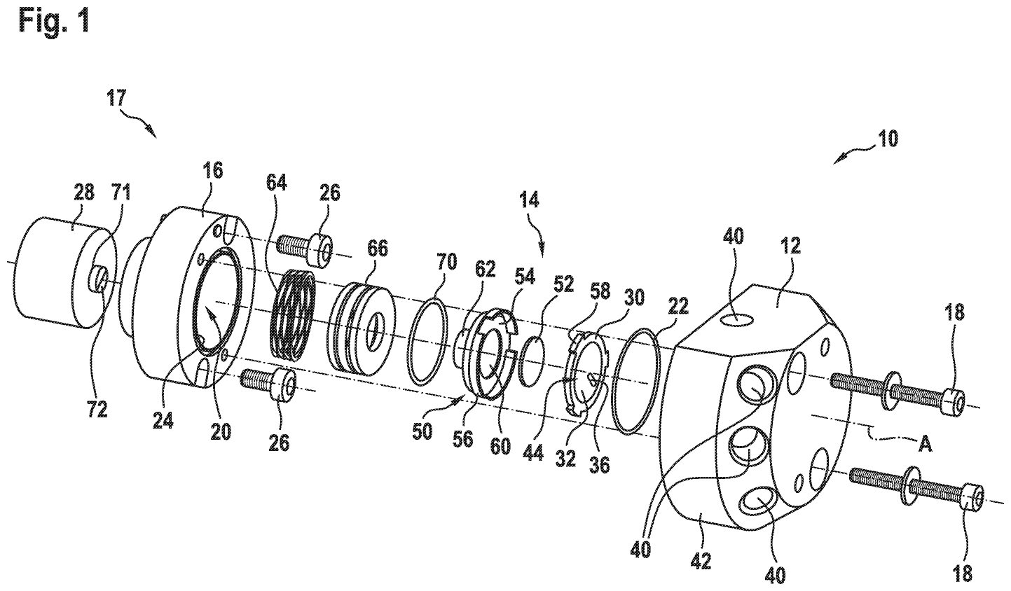

FIG. 1 shows a rotary valve 10, which comprises a stator member 12 and a rotor assembly 14, which is accommodated in a valve body 16. An outer part of the stator member 12 and the valve body 16 may be seen as a housing 17 of the rotary valve 10. The stator member 12 is mounted to the valve body 16, for example with screws 18. Between the stator member 12 and the valve body 16, a cavity 20 is formed, which accommodates the rotor assembly 14.

Between mating surfaces of the stator member 12 and the valve body 16, an O-ring 22 made of an elastomeric material is provided in a recess 24 in the valve body 16, which tightens a seal between the stator member 12 and the valve body 16.

Further screws 26 may be attached by means of a snap-fit connection to the valve body and used to attach the valve body 16 to further components of the rotary valve 10, such as a step motor 28.

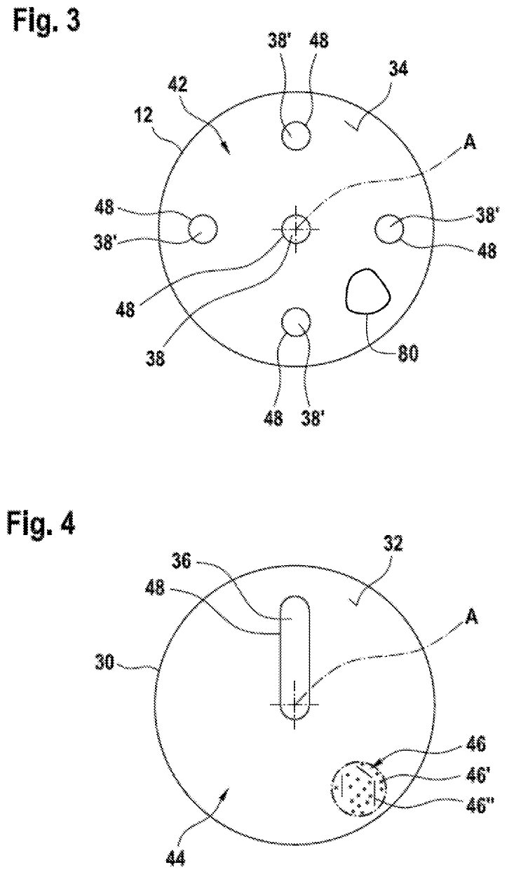

The rotor assembly 14 comprises a rotor member 30, which is pressed against the stator member 12. In particular, the rotor member 30 has a planar rotor face 32 and the stator member 12 has a planar stator face 34, which touch each other to form a liquid tight seal. A view on the stator face 34 is shown in FIG. 3 and a view on the rotor face 32 is shown on FIG. 4. Both the stator face 34 and the rotor face 32 may be circular areas and/or may be provided by disc-shaped parts of the rotor member 30 and the stator member 12, respectively.

In the rotor member 30, a rotor channel 36 in the form of a groove is provided. In specific rotational positions of the rotor member 30 with respect to the stator member 12, the rotor channel interconnects two stator channels 38, 38′. As shown in FIG. 3, for the present valve 10, four different positions are possible for connecting the central stator channel 38 with one of the other stator channels 38′. All of the stator channels 38, 38′ have a port or channel opening into the stator face 34, which is aligned substantially parallel to a rotation axis A of the rotor assembly 14. The rotor channel 36 is aligned substantially orthogonal to the rotation axis A.

In the stator member 12, receptacles and/or openings 40 interconnected with the stator channels 38, 38′ are provided, which may be used for connecting hoses and/or fluidic tubing which transport the liquid to and from the rotary valve 10.

It has to be noted that other forms of rotor channels, such as a rotor channel interconnecting three stator channels, and/or other numbers and/or arrangements of rotor channels and/or stator channels are possible.

One of the stator member 12 and the rotor member 30 may be made of ceramics material 42. The other one of the stator member 12 and the rotor member 30 may be made of a polymer material 44 mixed with particles 46. In the following, it will be assumed that the stator member 12 is made of ceramics material and that the rotor member 30 is made of the polymer material mixed with particles 46. However, it is also possible in the following that the choice of material is the other way around. The ceramics material 42 may be coated with DLC 80, where a portion of the DLC 80 that coats the ceramics material 42 is depicted in FIG. 3.

The polymer material 44 may be and/or may comprise a fluorocarbon, such as ethylene tetrafluoroethylene (ETFE). The ceramics material 42 may be and/or may comprise aluminum oxide (Al₂O₃), and optionally coated with DLC 80.

The particles 46 may be and/or may comprise beads 46′ and/or fibers 46″. The particles 46 may be made of glass and/or carbon. The particles 46 may have a diameter of less than 50 μm, such as about 30 μm, and/or may have a volume content between 10% and 30%, such as about 20%, with respect to the polymer material 44.

The particles 46 may be electrically conducting, such as carbon particles or carbon fibers. The polymer material 44 mixed with particles may be electrically conducting. In such a way, the forming of an electric charge may be prevented.

It has to be noted that stator member 12 may be made one-piece from the ceramics material 42 and/or that the rotor member 30 may be made one-piece of the polymer material 44 mixed with the particles 46.

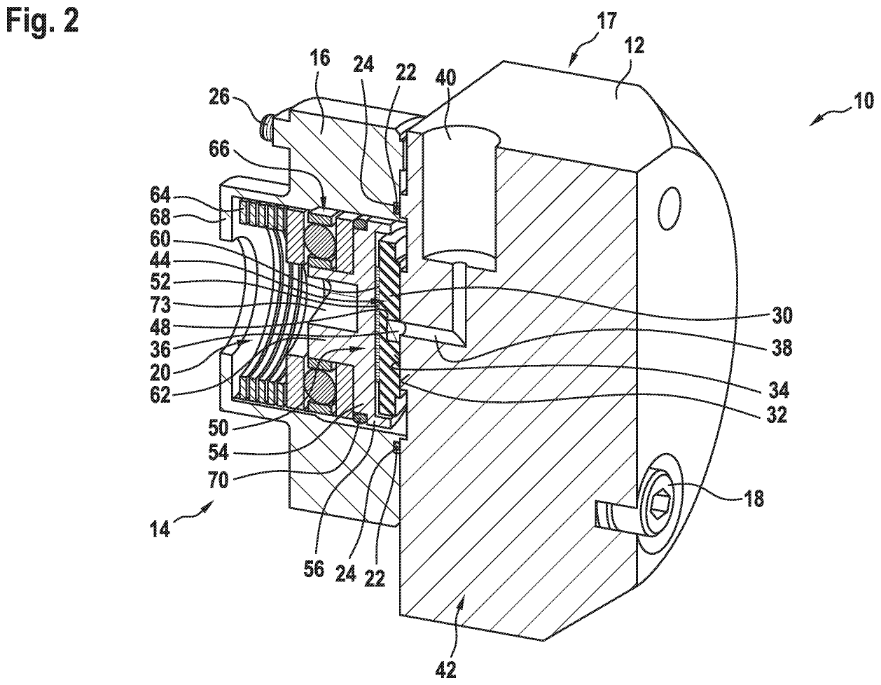

The stator member 12 may be made in the following way. A stator member preform may be cast from the ceramics material 42 in substantially the outer form as shown in FIGS. 1 and 2. The channels 38, 38′, openings 40, etc. may be machined into the preform. After that at least the surface facing towards the rotor member 30, i.e. the stator face 34, may be coated with DLC 80, for example with vapor deposition.

The stator face 34, i.e. the surface of the stator mating the rotor face 32, may be finished with a lapping process to achieve a flat surface with soft edges 48. This lapping process may create a uniformly smooth surface to enable effective and reliable valve sealing performance. The lapping process may prevent sharp edges 48 on the ceramics stator member 12 from wearing or damaging the polymer rotor member 30.

With the lapping process, the edges 48 of the stator channels 38, 38′ may be rounded with a minimum radius between 15 μm and 35 μm, such as about 20 μm.

The rotor member 30 may be made in the following way. The rotor member may be machined and/or injection molded from an ETFE polymer formulation with 20% glass beads, glass fibers, carbon beads and/or carbon fibers. Lapping of the rotor face 32 after machining and/or molding may be performed. Alternatively or additionally, diamond-turning may be used to achieve a flat and smooth rotor face 32. In particular, glass beads and/or fibers filling ETFE may improve resistance to wear and cold flow. Furthermore, molding the polymer rotor member may be desirable to minimize the occurrence of pits formed by glass beads and/or fibers dislodged during the machining or lapping processes.

As shown in FIGS. 1 and 2, the rotor assembly 14 furthermore comprises a coupling element 50, which accommodates the rotor member 30 and a disc-shaped balancing member 52 arranged between the rotor member 30 and the coupling element 50. The coupling element 50 may comprise a disc-shaped part 54 with an interrupted border 56, which forms an opening, in which the rotor member 30 is provided. The rotor member 30 may have fingers 58 engaging into the interrupted border 56, such that a rotational movement of the rotor member 30 and rotor channel 36 position may be transferred and/or indexed from the coupling element 50 to the rotor member 30. Furthermore, the position of the rotor channel, which may be indexed to a plurality of stator channel positions, may be aligned with the step motor driveshaft 71 by means of a driveshaft flat 72 and a coupler flat 73.

The balancing member 52 is arranged in a recess 60 in the coupling element 50 and in particular in the disc-shaped part 54. The balancing member 52 may be made of an elastomeric material, such as rubber. The balancing member 52 may be disc-shaped and/or may have a diameter equal to or smaller than a diameter of the rotor face 32.

The coupling element 50 furthermore has a shaft 62 adapted to engage an axis of the motor 28. The coupling element 50 may have a shaft recess for receiving the axis of the motor 28 with a coupler flat 73, which may index the rotor channel position to a plurality of stator channel positions.

The coupling element 50 may be made of an electrically conducting material, such as stainless steel. With a coupling element 50 made of an electrically conducting material, the rotor member 30 may be grounded and a forming of static charge may be reduced.

The rotary valve 10 furthermore comprises a preload spring 64 and a thrust bearing 66 arranged in the cavity 20 of the valve body 16. The spring 64 is supported by a shoulder 68 of the valve body 16 and presses the bearing 66 against the coupling element 50, which presses the rotor member 30 against the stator member 12. The force from the coupling element 50 is transferred via the balancing member 52. An O-ring seal 70 may be provided between the bearing 66 and the coupling element 50. The O-ring seal 70 may be made of elastomeric material. Seal 70 may serve two purposes: prevent any errant fluid from reaching the metal parts in the valve or drive mechanism and/or physically center and align the rotor with the centerline of the valve assembly. This centering may also be accomplished in other ways such as with bearings, sleeve arrangements or by extending the rotor member fingers to guide against the walls of the valve body.

The spring 64 and the balancing member 52 may be seen as a rotor preload system of the rotary valve 10. The preload spring 64 may provide the force required to seal the rotor face 32 against the stator face 34. Without the balancing member 52, a flexing of the rotor member 30 made of polymer 44, for example due to an unevenly distributed preload force, assembly misalignment and/or rotor member 30 thickness tolerance variation, may cause a leak. The balancing member 52 may compensate for these effects by preventing the rotor member 30 from flexing under the force of the preload spring 64 and may encourage the rotor face 32 to fully seat against the stator face 34. The recess 60 in the coupling element 50 may keep the balancing member 52 centered on the rotation axis A. This may enable a proper alignment of the preload force on the rotor member 30.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

1. A rotary valve, comprising:
a stator member with a planar stator face, the stator member having a plurality of stator channels for conducting a fluid; and
a rotor member with a planar rotor face facing and in contact with the stator face, the rotor member having at least one rotor channel,
wherein:
the rotor member is rotatable with respect to the stator member, such that in specific rotor positions, the rotor channel interconnects two of the stator channels, such that the two stator channels are in fluid communication with each other;
one of the stator member and the rotor member is made of ceramics material, wherein the ceramics material is coated with a diamond-like carbon (DLC); and
the other one of the stator member and the rotor member is made of a polymer material.

2. The rotary valve of claim 1, wherein the polymer material comprises at least one of a fluorocarbon and ethylene tetrafluoroethylene (ETFE).

3. The rotary valve of claim 1, wherein the ceramics material comprises aluminum oxide (Al₂O₃).

4. The rotary valve of claim 1, wherein the polymer material is mixed with particles.

5. The rotary valve of claim 4, wherein the particles comprise carbon.

6. The rotary valve of claim 4, wherein the particles have a diameter of less than 50 μm.

7. The rotary valve of claim 4, wherein the particles have a volume content between 10% and 30% with respect to the polymer material.

8. The rotary valve of claim 1, wherein either the stator member or the rotor member, or both the stator member and the rotor member, is made one-piece from the ceramics material that is coated with the DLC.

9. The rotary valve of claim 1, wherein the other one of the stator member and the rotor member is made one-piece of the polymer material.

10. The rotary valve of claim 1, wherein the rotor channel is a groove in the rotor face.

11. The rotary valve of claim 1, wherein the stator channels are axially extending with respect to an axis of rotation of the rotor member.

12. The rotary valve of claim 1, wherein:
the rotor member is part of a rotor assembly that comprises a coupling element configured to be connected to an electrical motor;
a balancing member arranged between the coupling element and the rotor member; and
the balancing member is made of a polymer material having a elasticity that is higher than an elasticity of the polymer material of the stator member.

13. The rotary valve of claim 1, further comprising:
a housing part, in which the rotor assembly is rotatably mounted;
a spring arranged in the housing part between the coupling element and a shoulder of the housing part for pressing the rotor member against the stator member; and
a bearing element arranged between the spring and the coupling element.

14. A rotary valve, comprising:
a stator member with a planar stator face, the stator member having a plurality of stator channels for conducting a fluid; and
a rotor member with a planar rotor face facing and in contact with the stator face, the rotor member having at least one rotor channel,
wherein:
the rotor member is rotatable with respect to the stator member, such that in specific rotor positions, the rotor channel interconnects two of the stator channels, such that the two interconnected stator channels are in fluid communication with each other;
one of the stator member and the rotor member is made of ceramics material; and
the other one of the stator member and the rotor member is made of a polymer material comprising electrically conducting particles, such that the other one of the stator member and the rotor member is electrically conductive.

15. The rotary valve of claim 14, wherein the electrically conducting particles comprise carbon particles and/or carbon fibers.

16. The rotary valve of claim 15, wherein the carbon particles and/or carbon fibers have a volume content of between 10% and 30% with respect to the polymer material.

17. The rotary valve of claim 14, wherein the ceramics material comprises aluminum oxide (Al₂O₃), wherein the ceramics material is coated with a diamond-like carbon (DLC).

18. The rotary valve of claim 14, wherein the electrically conducting particles are configured to prevent a static charge from building up on the stator member and the rotor member.

19. The rotary valve of claim 14, wherein the other one of the stator member and the rotor member is electrically grounded.

20. The rotary valve of claim 14, wherein:
the stator member is made of the ceramics material and at least the planar stator face of the stator member is coated with a diamond-like carbon; or
the rotor member is made of the ceramics material and at least the planar rotor face of the rotor member is coated with a diamond-like carbon.
